(19) United States
(12) Patent Application Publication
(10) Pub. No.: US 2007/0179855 A1
(43) Pub. Date: Aug. 2, 2007

(54) System for optimizing energy purchase decisions

(75) Inventors: Ismael Enrique Arciniegas Rueda, Arlington, VA (US); Anil Kumar Suri, Tarrytown, NY (US); Vikram Bakshi, Westport, CT (US); Glenn Bradley Christensen, New Lenox, IL (US); Andrew Mark Singer, Baltimore, MD (US); Gary R. Bradley, Lemont, IL (US); Brian Hayduk, Tarrytown, NY (US); Abhinav Krishna, Chevy Chase, MD (US); Alvaro Ignacio Arciniegas Rueda, Troy, NY (US); Wei Li, Parsippany, NJ (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Constellation Energy Group, Inc., Baltimore, MD (US)

(21) Appl. No.: 11/657,047

(22) Filed: Jan. 24, 2007

Related U.S. Application Data
(60) Provisional application No. 60/762,542, filed on Jan. 27, 2006.

(51) Int. Cl. G07G 1/14

(52) U.S. Cl. 705/14; 705/412

(57) ABSTRACT

A method of determining an optimal energy portfolio for a customer includes: quantifying the customer's risk/reward profile; obtaining customer data, including historical and forward customer data, said customer data including at least customer budgetary constraints; obtaining market data, including historical and forward market data; and determining, as the optimal energy portfolio for the customer, an energy portfolio based at least in part on (i) the customer's risk/reward profile, (ii) the customer's budget constraints, (iii) the customer data; and (iv) the market data.

### CROSS-REFERENCE To CO-PENDING APPLICATIONS

The present invention is related to and claims priority from U.S. Provisional Patent Application No. 60/762,542, entitled “System for Optimizing Energy Purchase Decisions,” filed Jan. 27, 2006 [atty. docket 2679-0002], the entire contents of which are incorporated herein by reference.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This relates to energy purchasing, and, more specifically to systems and methods for optimizing energy purchase decisions.

### INTRODUCTION & BACKGROUND

Energy, e.g., in the form of electricity, can be a significant budget item for any business. FIG. 1 shows the conventional (prior art) framework (generally denoted 100) for energy purchasing. As shown in the drawing, a customer 102 may either purchase its energy requirements from a utility company 104 (which may or may not be regulated and which may or may not be a public company). The utility company may trade energy on one or more energy markets 106. The company then obtains its energy (in whatever form) from one or more energy providers 108 in accordance with its contract arrangement with the utility company 104. In a deregulated energy market, e.g., as shown in FIG. 2, the customer 102 may trade directly in the various energy markets 106.

In the presence of open and fully or partially unregulated energy markets, a business may find budget planning difficult. Instead of predictable costs, a business may be subject to actual or perceived unpredictability. In effect, deregulation of energy markets has forced all energy consumers, regardless of the nature of their underlying businesses, to become energy traders. To avoid the potential perceived unpredictability and volatility of energy markets, many businesses enter into long-term energy contracts with their providers. These long-term contracts, while providing a low degree of risk and a related high degree of predictability, are often not the most economically efficient or financially beneficial arrangements. At another extreme, a business may try to assume a much greater risk and purchase some or all of its energy requirements on a spot market. This approach, of course, can lead to major budget deviations if the energy costs are fluctuating highly. In addition, this approach has the risk of budget overruns if the cost of energy on the spot market increases significantly.

It is therefore desirable to provide energy consumers (generally referred to herein as customers) with a framework for evaluating the cost-risk tradeoffs associated with the energy market. It is further desirable to provide customers with the ability to make economically efficient short and long-term energy planning decisions.

As used herein the term “business” generally refers to a business entity such as a company, corporation or the like.

As used herein the term “energy” refers to any type of energy or energy related commodity that is consumed or used by a business, regardless of the manner in which that energy is generated or provided to the business. Energy includes, without limitation, electricity, whether generated by coal, oil, hydroelectric facility, nuclear facility, solar, wind or any other means.

### BRIEF DESCRIPTION OF THE DRAWINGS

The following description, given with respect to the attached drawings, may be better understood with reference to the non-limiting examples of the drawings, wherein:

FIG. 1 shows a conventional framework for energy purchasing;

FIG. 2 is a diagrammatic overview of the framework within which embodiments of the present invention operate;

FIG. 3 is a flowchart showing operation of certain aspects of embodiments of the present invention;

FIG. 4 graphically depicts aspects of determining a customer's risk/reward profile;

FIG. 5 is a graph showing a risk minimization frontier;

FIG. 6 is a graph showing a consistent efficiency frontier for a particular budget;

FIG. 7 is a graph showing a specific example of an efficiency frontier for a particular budget for a specific client;

FIG. 8 is a schematic of various aspects of the process flow;

FIGS. 9A-9C depict exemplary storage schema; and

FIG. 10 depicts a diagrammatic overview of a framework within which embodiments of the present invention operate.

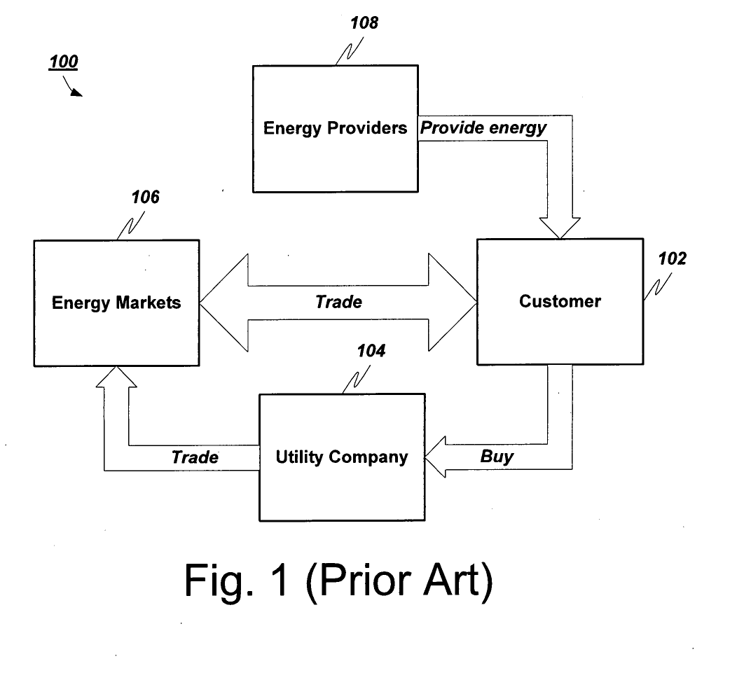

### THE PRESENTLY PREFERRED EXEMPLARY EMBODIMENTS

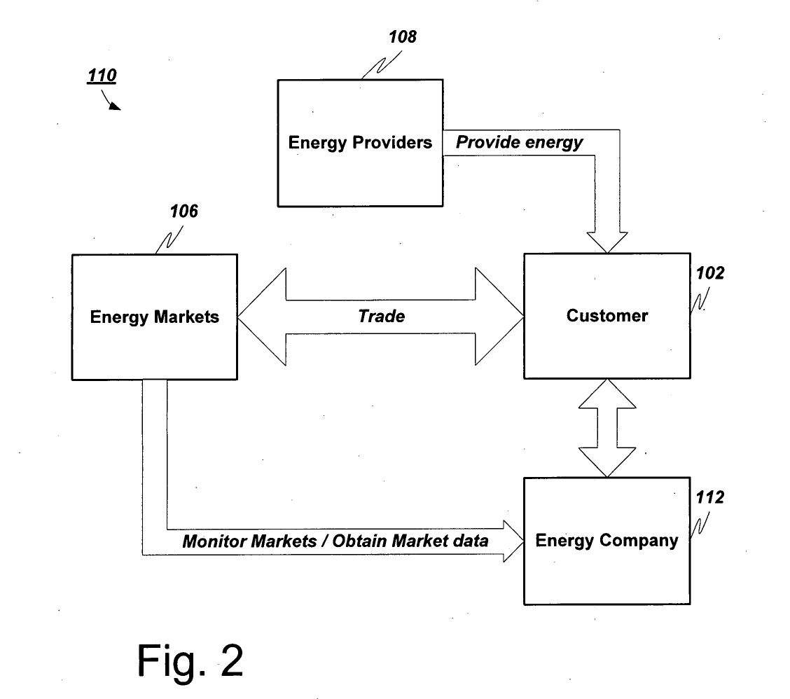

As shown in FIG. 2, the present invention provides a framework (generally denoted 110) for energy purchasing and provisioning. In the embodiment shown, an energy company 112 interacts (as described in detail below) with the customer 102 and, based at least in part on information provided by each customer, provides the customer with an energy purchase plan to meet that customer's energy and budgetary requirements, all within that customer's acceptable risk levels. In the presently preferred embodiment, the customer then trades on the energy markets in accordance with the plan provided by the energy company 112. It should be understood that the energy markets 106 trade in contracts for energy which is to be provided by the energy providers 108.

In presently preferred exemplary embodiments of the invention, the customer is provided with a framework to assess the cost-risk tradeoffs associated with their energy purchases. In preferred embodiments, cost is represented as the current expected forward cost based on the traded markets and adjusted for historically observed forward to spot premium, while risk is represented as the variance implied in the traded market and adjusted for the customer view of market variability in terms of potential upside versus the downside risk.

The cost-risk tradeoffs are generally customer specific. It is therefore preferable for the energy company 112 to ascertain a risk profile for each customer. In addition, it is preferable for the energy company to obtain an energy usage profile for each customer. This energy usage profile may include information relating to prior usage and/or predicted future energy usage requirements.

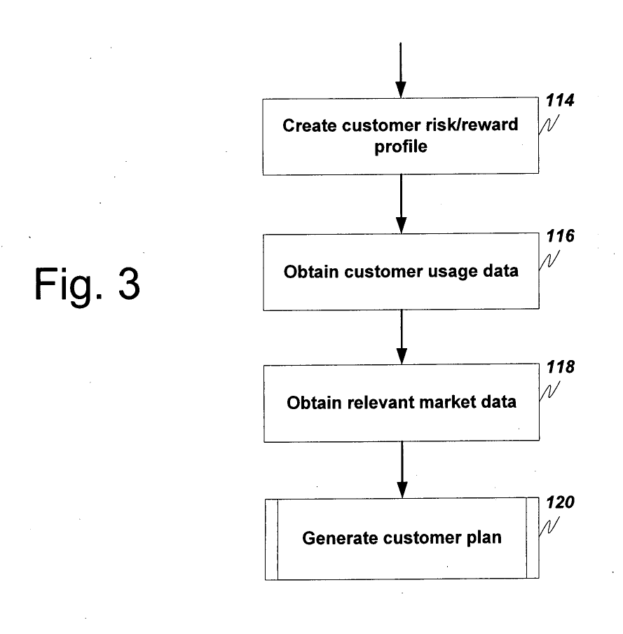

Operation of an embodiments of the present invention is described with reference to FIG. 2 and the flow chart in FIG. 3.

For a typical customer, first a customer risk/reward profile is determined (at 114). The customer's risk/reward profile may be determined based, at least in part, on the customer's responses to various questions. These questions may be asked in a questionnaire or online or in person. Exemplary questions are listed in the following tables which shows four categories of questions (budget, risk, downside tolerance and current hedging policies). Those skilled in the art will realize that other and/or different questions may be asked and that the answers to some of the questions may not be used in every case.

| Budget Questions | | |
|---|---|---|
| Question | Possible Responses | |
| How long do you currently set your energy | A <=1 year | B 1–2 years |
| budgets? | C 3–5 year | D >5 years |
| How long do you envision setting your | A <=1 year | B 1–2 years |
| energy budgets in future? | C 3–5 year | D >5 years |
| At what level are energy budgets managed? | A Facility | B Region/ |
| | | Division |
| | C National | D All of the |
| | | above |
| Can you pass energy budget over-runs to | Yes | No |
| your end use customer? | | |

| | | | | |
|---|---|---|---|---|
| What is the maximum increase or decrease | 0% | 5% | 10% | 20% |
| year to year in the budget you can absorb? | | | | |

| | Possible Responses | |
|---|---|---|
| | Reward | % Risk |
| Risk/Rewards Questions | Potential below | above |
| Question | Budget | Budgeted |
| Following choices indicate hypothetical | 0% | 0% |
| risk/rewards scenarios. Please indicate which | 3% | 10% |
| best describes your organization. | 7% | 30% |
| | 10% | 50% |

| | Possible Responses | |
|---|---|---|
| | | Probability |
| | | of 15% |
| Downside Tolerance | Meet/Beat | budget |
| Question | Budget | overrun |
| Note possible outcomes of four hypothetical | 0% | 0% |
| portfolios. Which portfolio would you feel | 3% | 1% |
| most comfortable holding? For example | 7% | 2% |
| “The chance of budget overrun” is the | 10% | 5% |
| probability that your actual electric costs | | |
| might exceed the initial budgeted amount. | | |

| Current Hedging Policies | | |
|---|---|---|
| Question | Possible Responses | |
| Is there a corporate policy for hedging energy | Yes/No | |
| commodities? | | |
| If “Yes”, what is the target hedge percentage. | 0–25 | |
| | 25–50 | |
| | 50–75 | |
| | 75–100 | |
| What percentage of electricity do you hedge? | 0–25 | |
| | 25–50 | |
| | 50–75 | |
| | 75–100 | |
| Is there a corporate policy for hedging | Foreign | Interest |
| financial instruments? | Currency | Rate |
| | Temperature | Weather |
| | Bond | Other |

The customer's responses to these questions are then quantified. For example, the customer's responses may be transformed to a quantitative risk score which allows the mapping of each costumer to a risk continuum as follows:

$$Risk Score = {\sum }_{j = 1}^{questions} {S}_{j} \times {W}_{j}^{k}$$

Where

Sⱼ=Risk score of question j

Wⱼ^{k}=Weight of question j in industry k (certain factors may have different weights in different industries).

Based on the value of the risk score, each company/customer can be categorized, e.g., as conservative, conservative moderate, moderate, moderate/aggressive, or aggressive. Each one of the risk profiles may be associated with two weights (α₁ and α₂) which represent the level of importance of minimizing downside and maximizing reward.

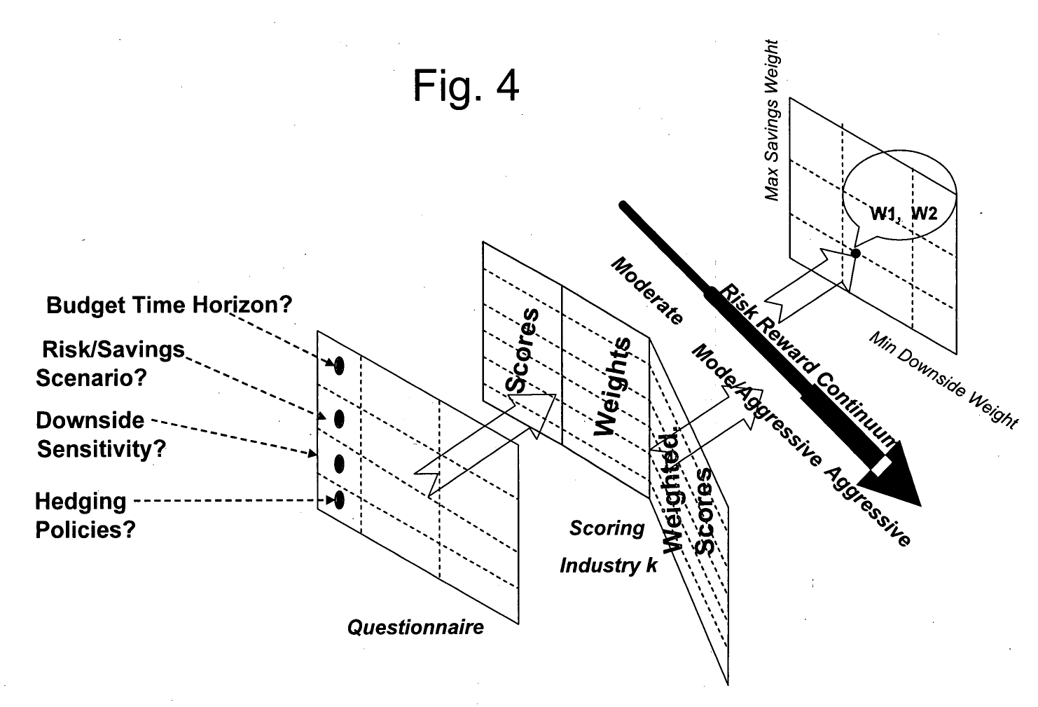

FIG. 4 graphically depicts aspects of determining a customer's risk/reward profile, and the following tables give exemplary scores and weights used to determine a customer's risk score.

| | | | Weighted | | |
|---|---|---|---|---|---|
| Question No. | Risk Score | Weight | Score | Min | Max |
| 1A | 4 | 10 | 40 | 10 | 40 |
| 1B | 3 | 10 | 30 | | |
| 1C | 2 | 10 | 20 | | |
| 1D | 1 | 10 | 10 | | |
| 2A | 1 | 15 | 15 | 15 | 60 |
| 2B | 2 | 15 | 30 | | |
| 2C | 3 | 15 | 45 | | |
| 2D | 4 | 15 | 60 | | |
| 3A | 1 | 20 | 20 | 20 | 80 |
| 3B | 2 | 20 | 40 | | |
| 3C | 3 | 20 | 60 | | |
| 3D | 4 | 20 | 80 | | |
| 4A | 1 | 10 | 10 | 10 | 10 |
| 4B | 2 | 10 | 20 | | |
| 4C | 2 | 10 | 20 | | |
| 4D | 1 | 10 | 10 | | |
| | | | Total | 65 | 200 |

| | | | Type 1 | |
|---|---|---|---|---|
| | | | (maximum | Type 2 |
| | | | savings | (Minimum |
| Risk category | Low | High | potential) | downside) |
| Conservative | 65 | 95 | 10% | 90% |
| Conservative/Moderate | 95 | 120 | 25% | 75% |
| Moderate | 120 | 150 | 50% | 50% |
| Moderate/aggressive | 150 | 180 | 75% | 25% |
| Aggressive | 180 | 200 | 90% | 10% |

Having determined a measure of the customer's risk/reward, the energy company 112 obtains the customer's usage data (at 116) and relevant market data (at 118). The customer usage data may be obtained from the customer or from other sources such as, e.g., energy providers 108. The customer's usage data may include historical and/or predicted usage or forward data. Historical data may include historic and/or current energy demands and uses (including, e.g., demand kW (kilowatts), on peak kWh (kilowatt hours), off-peak kWh, and non-TOU (time-of-use) kWh. Historic data may include load data, risk profile data, customer-specific business rules (e.g., maximum hedge percentage), and cost. Forward data may include adjusted load data, weather projections, conservation/demand-side initiatives, facilities plans (start-up/shut-down), load shift (requirements increases/decreases), budgetary goals/cost targets, product type restrictions (e.g., block, index, options), enterprise load-to-cost correlation data (e.g., aggregate v. regional/divisional v. site level).

Those skilled in the art will immediately realize, upon reading this description, that other and/or different customer data may be used.

In addition to information obtained from a questionnaire, the following information should be obtained from each customer: relative importance of risk in the future, customer's loss aversion, customer's budget requirements, and specific risk pressure points (e.g., minimum hedges). For the market, all risks are essentially equal. But for a specific customer, risks are not equal. For example, a customer may not think that a risk a few years away is of much importance. As another example, some customers may put higher weights on certain seasons than does the market.

Typically loss aversion trumps risk taking aversion. Customers are more likely to be loss averse when they have recently lost.

The market data are obtained from the energy markets 106 and are preferably in the form of contract information including energy costs. Market data may include historical market data relating to, e.g., regional specific energy factors (gas, oil, coal), power market prices (hourly, monthly, annual), weather, economic indicators and market volatility. Forward market data may include regional specific energy complex (gas, oil, coal), power market prices (monthly, annual), hourly/term premium (correlation matrix), weather, economic indicators, implied volatility.

Some of the customer and market data are preferably provided for each of the customer's energy-consuming locations or regions.

Customer and market historical and forward data are preferably obtained for three years back and three years forward.

As noted above, the energy markets 106 trade in contracts for energy to be provided by the energy providers 108. Therefore the market data include data about the various option prices available to customers.

Those skilled in the art will understand that the energy providers 108 may be limited in the geographic region(s) in which they can provide energy. These limitations may be based on physical or other constraints. Therefore the relevant market data for a particular customer will be market data associated with energy providers with the capacity (physical and otherwise) to provide energy to the customer.

Those skilled in the art will immediately realize, upon reading this description, that other and/or different market data may be used. Those skilled in the art will also realize that other and/or different time periods can be used for forward and historic data and for customer data and market data.

Having determined a measure of the customer's risk/reward, obtained the customer's usage data and the relevant market data, the energy provider 108 then generates a customer plan (at 120) that should meet the customer's requirements.

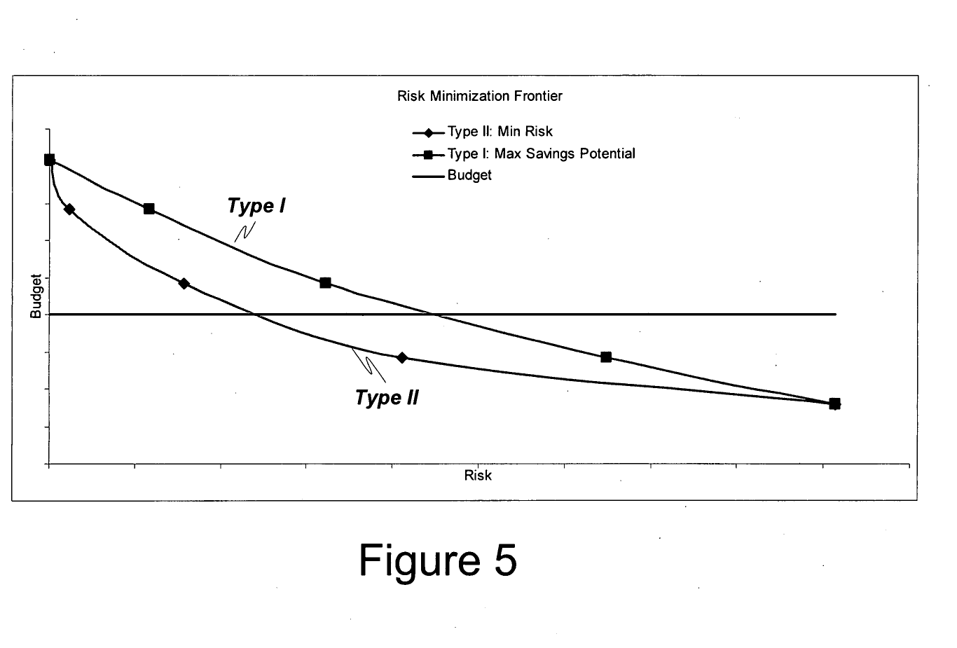

In order to generate/compute a customer plan for a given set of budgets, a universe of optimum portfolios is computed for each of two goals: downside minimization and savings potential. So, a first universe of portfolios is generated that minimize downside for a given sets of budgets. A second universe of portfolios is computed that maximizes savings potential for a given set of budgets. The graph in FIG. 5 has two curves, one for type I risk (maximum savings potential) and the other for type II risk (minimum risk).

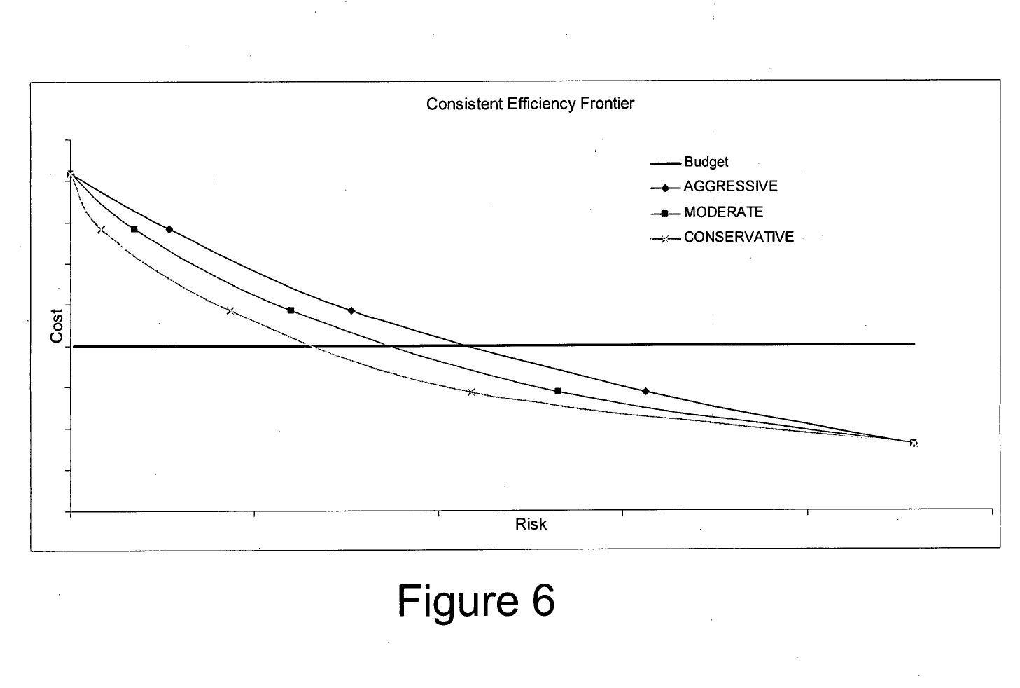

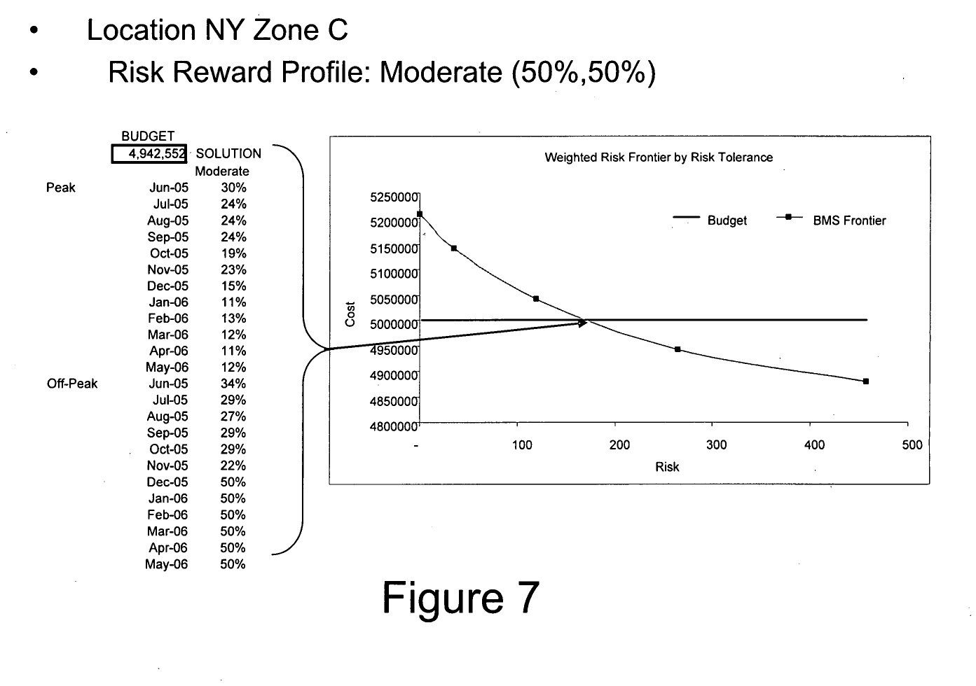

Next the optimum portfolios are combined based on the customer's risk/reward profile, as shown in the graph in FIG. 6 (which shows three portfolios, one for each of aggressive, moderate and conservative).

A frontier of optimum portfolios consistent with the customer's risk/reward is then provided to the customer.

When it comes to actual execution of certain portfolios, the market may constrain efficiency. This can happen for a number of reasons, including liquidity premiums, and minimum hedging volumes.

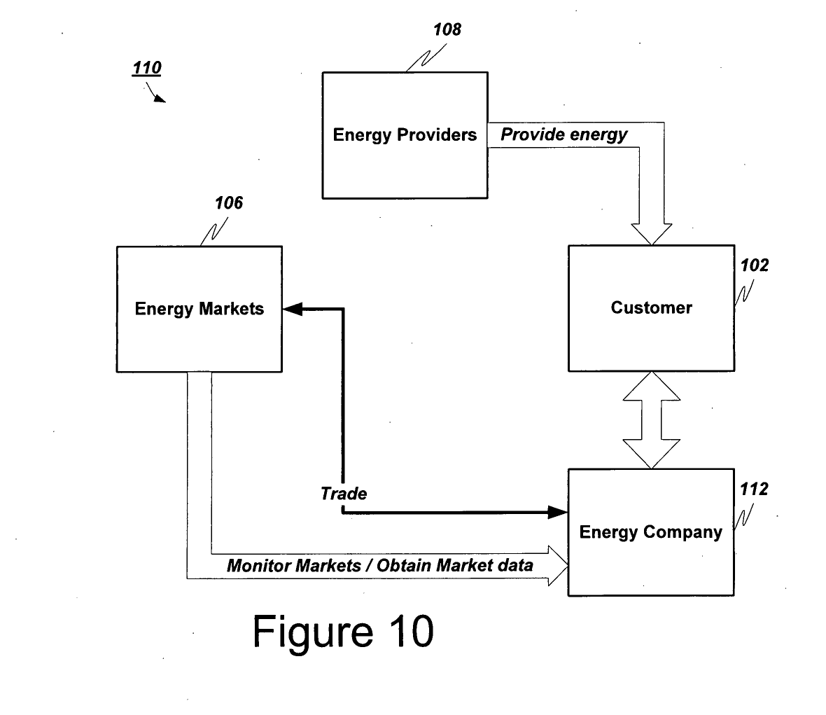

With an efficiency frontier computed for a particular customer, there is generally an expectation that the corresponding portfolio will be implemented by the customer. However, as shown in FIG. 10, in some cases the energy company 112 can perform the actual trades with the energy markets 106 on behalf of the customer 102. This scenario essentially provides a deregulated, customer specific energy company.

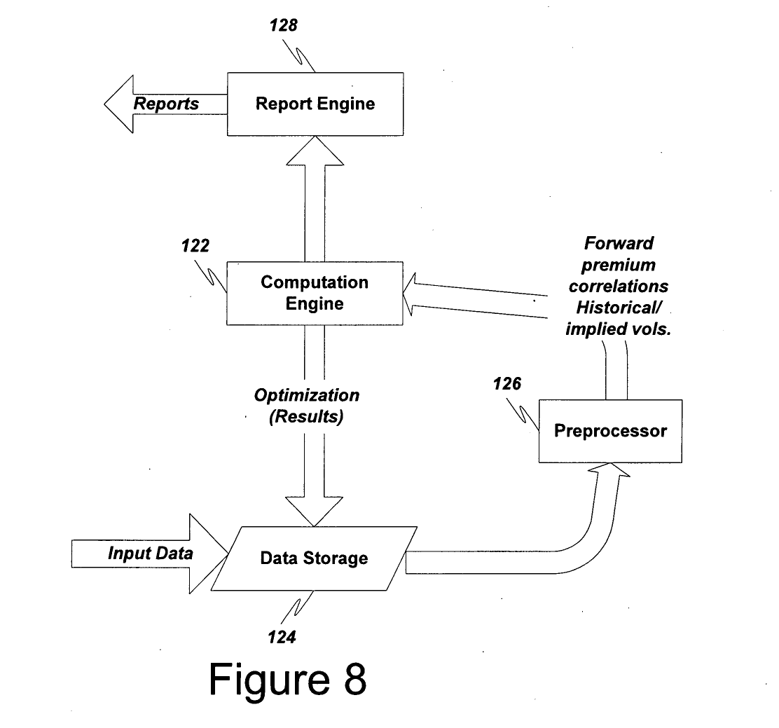

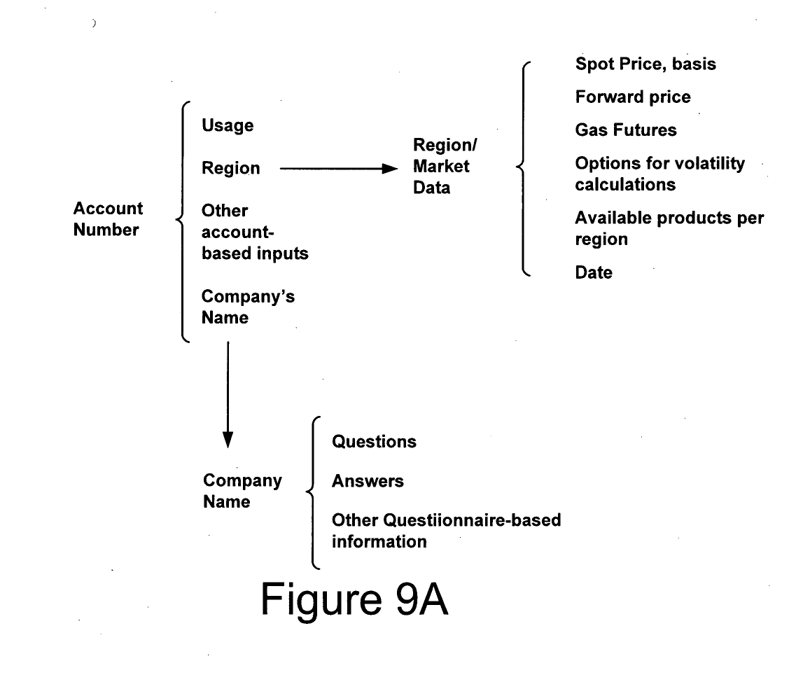

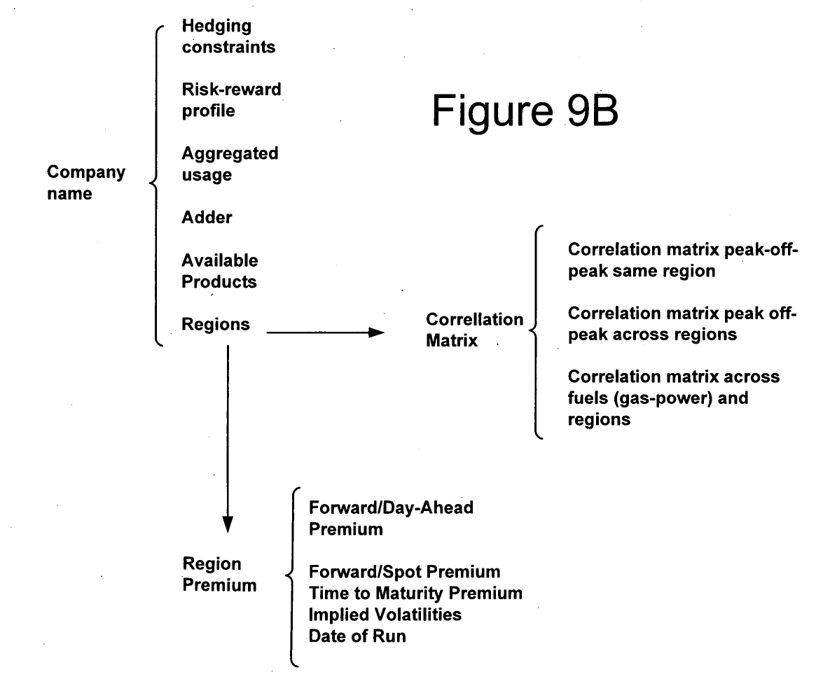

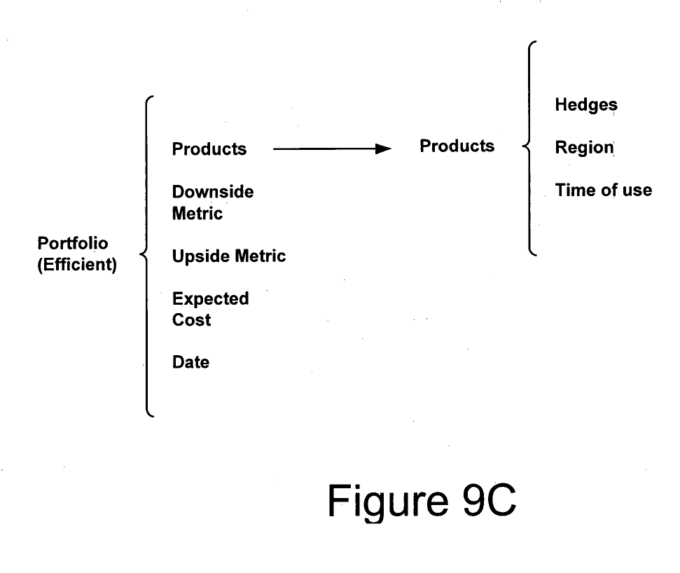

The computational aspects of the present invention may run on a typical computer having a general purpose processor (CPU) with appropriate internal memory (RAM, ROM and the like) and external storage (disks, etc.). FIG. 8 is a schematic of various aspects of the process flow according to embodiments of the present invention. As shown in FIG. 8 an energy provider 108 employs various computational elements or modules including a computation engine 122, data storage 124, a preprocessor 126, and a report engine 128. In a present implementation of an embodiment of the invention, the computation engine 122 uses S-PLUS, MATLAB, the data storage 124 is a SQL database, and the preprocessor 126 is S-PLUS/Excel. S-PLUS is an integrated suite of software facilities for data manipulation, calculation and graphical display. MATLAB is a registered trademarks of The MathWorks, Inc. Excel is a registered trademark of Microsoft Corporation.

### Data Storage

The data storage 124 may be implemented, e.g., using a relational database, which contains three main components: inputs storage, intermediate data storage, and, output results storage. The inputs storage should include the following elements:
1. Account based data: Usage, location, account based pricing inputs etc.
2. Market Based Data: Forwards and Spot prices (electricity, gas).
3. Questionnaire data.
4. Company's hedging constraints.

FIG. 5A shows an exemplary inputs storage schema.

The intermediate data storage includes the results associated with the regions' run of their pricing models as well as the results of the preprocessing analysis of the raw inputs. Intermediate data storage preferably includes at least the following elements:
1. Aggregated Usage by region from accounts
2. Adders. From runs from pricing models (automatic/personal request)
3. Risk/Reward Profile. From runs of risk/reward profile model
4. Forward/Spot premium. Continuously updated as new data comes in
5. Calculated Volatilities. From option based information.
6. Correlation Matrices. Continuously updated as new data comes in.

Correlation matrices should be computed with different levels of complexity: peak-off-peak same region, across several regions, across several fuels: electricity-gas. Correlation numbers are preferably to be estimated using a statistical approach that measures dependency and is not subject to outliers and non-normality. One of these approaches is Spearman (or rank correlation). Spearman's correlations are available in any statistical package as E-Views, S-PLUS, SAS, etc.

Implied volatilities from market data are computed, e.g., by trying different volatilities on the option pricing formula. The implied volatility is the volatility that generates the option price being seen in the market. Volatilities are computed from historical forward data. Volatilities are preferably updated as new data arrive.

FIG. 5B shows an exemplary intermediate storage schema.

Output storage generally refers to saving of all optimization results that are to be used by the Report Engine so that it can be replicated or compared with new runs. Output storage may include the following:
1. Set of portfolios on the efficiency frontier
2. Products and hedges associated to each on the efficient portfolios

FIG. 5C shows an exemplary output storage schema.

The preprocessing component 126 derives some of the inputs required by the computation engine 122 (e.g., by the optimizer). The preprocessor may be programmed in Vba Excel, S-PLUS, MATLAB or any other appropriate programming system.

In a presently preferred embodiment, the preprocessor aggregates loads by region. Granularity of aggregation is preferably monthly. If necessary, the preprocessor does interpolation.

The preprocessor computes the Forward/Spot premium as follows:
1. Create a daily average measure of spot price as follows:

$${SP}_{k} = {\sum }_{k = 1}^{DaysInMonth} \frac{{\sum }_{j}^{PeakOffpeak} \frac{{SP}_{j}^{k}}{PeakOffpeak}}{DaysInMonth}$$

Where

SPₖ=Average spot price of month k

SPⱼ^{k} is the spot price for hour j (peak/offpeak) for day k

PeakOffpeak is number of peak/offpeak hours

DaysInMonth is number of days in month
2. Compute the forward spot-premium for month k a given maturity (T-K) as follows:

$${Premium}_{k}^{T - K} = \frac{{F}_{K}^{T - K} - {SP}_{K}}{{SP}_{K}}$$

Where

F_{K}^{T-K} is the forward price for delivery in month k with time to maturity T-K

Premiumₖ^{T-K} is the risk premium for month k at time to maturity T-K
3. Update forward-spot premiums continuously for all regions as new data arrives.
4. Compute the forward day-ahead premium for PJM using a similar approach as in Step 2. This is for embodiments in which a customer may take a position in the real time versus day-ahead.

The computation engine 122 is a programming platform that implements optimization; computes risk metrics; and statistics.

The optimizer solves general portfolio non-linear optimization for mixes of several products under constraints. For instance, it should be able to compute mean-variance optimal portfolio (maximizing risk for a given expected return) with linear equality, inequality constraints, and integer constraints.

The optimizer is preferably able to maximize reward-utility for a given set of linear as well as nonlinear utility functions.

The optimizer should be able to compute traditional scenario based risk measures (e.g., VaR) for each one of the optimum points on the efficiency frontiers. Optimizer should be able to generate statistics that allow an analyst to assess the soundness of the optimization obtained. Optimizer should be able to store relevant results of optimizations in database. Specifically optimization portfolios and risk metrics.

Preferably the CE stores all its output.

S-PLUS, Matlab, Mathematica, or another similar program can be used to implement the requirements of the computation engine 122. Those skilled in the art will realize that, e.g., the Numerical Optimizer (NuOPt) of S-PLUS satisfies the Optimizer requirements.

The Report Engine 128 is used to generate reports for customers. In preferred implementations, the report engine 128 can produce so-called “drill down” reports and graphs, and so-called “drill horizontal” reports/graphs. These all display frontiers associated with a larger/smaller different universe of products.

In some embodiments, the report engine 128 is available via the web with an interactive capability to drill down to show further detail underlying the calculations (e.g.; the applicable forward curve used).

Preferably the report engine 128 will include a report archiving database.

The framework described herein is considered customer specific in that it determines portfolios that are consistent with each customer's risk/reward profile. The framework is efficient because it computes portfolios that achieve minimum costs for a given risk level and risk/reward profile. The framework is flexible in that it offers customers with a large universe of optimum portfolios.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A method of determining an optimal energy portfolio for a customer, the method comprising:
quantifying the customer's risk/reward profile;
obtaining customer data, including historical and forward customer data, said customer data including at least customer budgetary constraints;
obtaining market data, including historical and forward market data;
determining, as the optimal energy portfolio for the customer, an energy portfolio based at least in part on (i) the customer's risk/reward profile, (ii) the customer's budget constraints, (iii) the customer data; and (iv) the market data.

2. A method of determining an optimal energy portfolio for a customer, the method comprising:
quantifying the customer's risk/reward profile;
determining, as the optimal energy portfolio for the customer, an energy portfolio based at least in part on the customer's risk/reward profile and on the customer's budget constraints.

3. A method as in claim 2 wherein the optimal energy portfolio is determined based also on market data.

4. A method as in claim 3 wherein the market data include historical market data.

5. A method as in claim 4 wherein the historical market data include one or more of: regional specific energy data, power market prices, weather data; economic indicators; and market volatility.

6. A method as in claim 3 wherein the market data include forward market data.

7. A method as in claim 6 wherein the forward market data include one or more of: regional specific energy data; power market prices; hourly/term premium data; weather data; economic indicators; and implied volatility.

8. A method as in claim 2 wherein the optimal energy portfolio is determined based also on customer data.

9. A method as in claim 8 wherein the customer data include at least one of historical data and forward data.

10. A method as in claim 9 wherein the customer data include historical data and wherein the historical data include one or more of: customer load data; customer-specific business rules; and cost.

11. A method as in claim 9 wherein the customer data include forward data and wherein the forward data include one or more of: adjusted load data; weather projections; conservation/demand-side initiatives; facilities plans; load shift data; budgetary goals/cost targets; product type restrictions; enterprise load-to-cost correlations.

12. A method as in claim 9 wherein the historical data goes back three years and the forward data goes forward three years.

13. A method as in claim 2 further comprising:
providing the customer with the optimal portfolio;
tracking performance of the optimal portfolio; and
modifying the optimal portfolio in response to changing market and/or customer conditions.

14. A method as in claim 2 further comprising:
implementing the customer's optimal portfolio by executing at least one trade associated with the portfolio.
